(19) United States
(12) Patent Application Publication
(10) Pub. No.: US 2009/0187508 A1
(43) Pub. Date: Jul. 23, 2009

(54) Business method for using a phone to transact financial transactions

(76) Inventor: Nicolas Placide, Miami, FL (US)

Correspondence Address: RUBEN ALCOBA, ESQ., 3399 NW 72 AVENUE, SUITE211, MIAMI, FL, 33122, US

(21) Appl. No.: 12/011,139

(22) Filed: Jan. 23, 2008

(51) Int. Cl. G06Q 40/00; G06Q 30/00; H04L 9/32

(52) U.S. Cl. 705/72; 705/75; 705/39

(57) ABSTRACT

A business method for using phones to transact financial transactions in a secured and verified manner. The business method for using phones to transact financial transactions comprises registering the user with a registration system. Having the user initiate a financial transaction over a specific telephone. Verifying if the initiated user financial transaction is legitimate. Lastly, transferring funds in accordance with user instructions previously provided.

### BACKGROUND

Presently there are all types of financial crimes being committed by white collar criminals. Among the most common crimes committed are credit card fraud and credit theft.

Most white collar criminals only need basic information from their victims, e.g., their name, date of birth and social security number. This information is easily accessible over the Internet. In fact, not only can you get that information, you can get one's employment history and address through most credit bureaus by simply supplying the basic information provided above and a form of payment.

The inventor of the present invention realized he had to invent a financial device that would not be easily copied by white collar criminals. He realized the device had to be an active rather than a passive device. The device had to be interactive. The device had to be initially activated by the user, the user had to instruct the device of a certain type of financial transaction to process, the device had to process the user's request, the device had to check the identity of the user in a secure manner, and lastly the device had to deliver the funding associated with the financial transaction to a third party.

The inventor further realized that if he could develop a financial device that could securely transfer funds over phone lines that he would be able to eliminate the need of carrying passive financial devices, such as a credit card, checks or cash, thereby minimizing the crimes associated with carrying credit cards, checks or cash.

An object of the present invention is to provide a user with a financial device that will insure that any funds he wishes to transfer to any third party is verified prior to the funds being released to a third party.

Another object of the present invention is to prevent white collar criminals from using a user's financial account.

A further object of the present invention is to provide a user with an alternative means to purchase items besides cash, checks or credit.

Yet a further object of the present invention is to insure that a user using the financial device does not overdraw his financial accounts.

Still a further object of the present invention is to provide the user with a financial device that can print or display a barcode that can be redeemed for cash or used as a form of payment at third party outlets.

For the foregoing reasons, there is a need for a business method for using phones to transact financial transactions in a secured and verified manner.

### SUMMARY

The present invention is directed to a business method for using phones to transact financial transactions in a secured and verified manner. The business method for using phones to transact financial transactions comprises registering the user with a registration system. Having the user initiate a financial transaction over a specific telephone. Verifying if the initiated user financial transaction is legitimate. Lastly, transferring funds in accordance with user instructions provided when the user initiated the financial transaction.

In the registering the user with a registration system step, the registration system step comprises the steps of providing a user with a registration system. Having the user submit his registration information. Having the registration system validate the user's information and then issuing the user a verification code. Having the registration system call the user and instructing the user to enter the verification code and other information. Having the user enter the verification code. If verification code entered is valid, then having the user enter a pin and a shopping code, the codes must be different, then having the user record a voice print, and lastly having the user instruct how his account is to be funded. Verifying that the funding source is the users, if so, continuing with the registration steps, if not flagging the user. Mailing an address verification code to the user, wherein the user is made to manually enter his information into the system to fully unlock his account, thereby allowing him to transact unabridged financial transactions. Lastly, having the user manually enter his information into the system.

In the having the user initiate a financial transaction over a specific telephone, the initiating financial transaction step comprises the steps of having the user call the registration system from his registered phone. Checking the telephone number to insure that it is the users registered telephone number, if so continuing with transaction. Instructing the user to enter the type of transaction desired. Having the user enter transaction. Summarizing transaction to the user and then hanging up.

As seen in FIG. 8, in the verifying if the initiated user financial transaction is legitimate step, the verifying step comprises the steps of calling the user and playing the voice print and instructing user to enter the pin number. Then, if the user recognizes his voice print, having the user enter his pin. Lastly, checking the pin for authenticity, if authentic, then continuing with the transaction, if not then repeating the above two steps a predetermined amount of times prior to flagging the user and terminating the transaction.

As seen in FIG. 9, in the transferring funds in accordance with user instruction step, the step comprises instructing the registration system to check for the availability of funds, if funds are available, then transaction shall continue, if funds are not available, then transaction shall be either placed on hold or terminated, if transaction does not originate from the user, then the account will be flagged for monitoring and the transaction shall be terminated. If the funds are available, then withdrawing the funds from the source previously provided by the user, passing the funds through the registration system, and delivering the funds to a third party or location. The funds may be transferred to a third party or location by providing a validation code to the user that corresponds with the transaction. The user may be able to display the bar code in his cellular phone or he may download the code from a computer.

### DRAWINGS

These and other features, aspects, and advantages of the present invention will become better understood with regard to the following description, appended claims, and drawings where:

FIG. 1 shows a flow chart showing the first step of registering a user within the registration system of the business method for using a phone to transact financial transactions;

FIG. 2 shows a flow chart showing the second step in registering a user within the registration system of the business method for using a phone to transact financial transactions;

FIG. 3 shows how a user initiates a financial transaction using the business method for using a phone to transact a financial transaction;

FIG. 4 shows a certain type of financial transaction, routine to send money with secure phone cash, conducted using the business method for using a phone to transact a financial transaction;

FIG. 5 shows a certain type of financial transaction to make a payment to a secure phone cash merchant number, conducted using the business method for using a phone to transact a financial transaction;

FIG. 6 shows a certain type of financial transaction to request release of cash, conducted using the business method for using a phone to transact a financial transaction;

FIG. 7 shows a certain type of financial transaction to purchase items sold through secure phone cash system, conducted using the business method for using a phone to transact a financial transaction;

FIG. 8 shows the verification step of verifying if the initiated user financial transaction is legitimate of the business method for using a phone to transact a financial transaction;

FIG. 9 shows how the registration system processes different types of transactions;

FIG. 10 shows a subroutine of how funds are transferred from one user to another using the above business method;

FIG. 11 shows a subroutine to transfer funds to a registered secure phone cash vendor using the above business method;

FIG. 12 shows a routine to issue a bar code as payment verificator using the above business method;

FIG. 13 shows a routine to generate an order to issue a purchased item through secure phone cash phone ordering using the above business method;

FIG. 14 shows a routine to generate a bar code using the above business method;

FIG. 15 shows how a user would use the above business method to shop online;

FIG. 16 shows how a user could use the above business method to shop at a store using a secure phone cash system; and

FIG. 17 shows how a user could withdraw cash with a secure phone cash system.

### THE FOLLOWING ARE DEFINITIONS TO INTERPRET DRAWINGS

Loop: A sequence of instructions that repeats either a specified number of times or until a particular condition is met.

Flag: A variable or memory location that stores true-or-false, yes-or-no information.

Fatal Flag: A flag which causes for a transaction to be canceled.

For example, let's say that we wanted to give a user up to 3 chances to enter their password. Then, in this particular situation, the flag would have a value of 3. We set up for a counter to start at their first attempt. The value of that counter is incremented with each failed attempt and is checked every time against the value of the flag. Until the counter reaches that value, the user is allowed to start over (loop). However, if the counter were to reach that predetermined value, the loop would end and the transaction would be canceled (fatal flag).

Cashcode: An identifier, often a barcode, sent to the user by the system. Once scanned, or manually typed in by a merchant, it reveals basic information about the user such as name, address, telephone number, etc. . . . It also contains an authorization number and expiration date. A cashcode works exactly the same as a credit or debit card but with the unique feature that the user may set their expiration date which could vary from years to just a couple of hours.

For example, let's say that a customer is about to go shopping and they don't expect to spend more than a $1,000 for that day. They would request a cashcode worth up to $1,000 that they could, for example, set to expire at 11:00 p.m. that night. After verification, the system would issue a cashcode that could then be used to withdraw money from an ATM or for shopping, etc. . . .

In other words, once issued, the cashcode works exactly the same as a debit or credit card. When used, it does not trigger a callback from the system, allowing for quick transactions at the register.

Shopping Code: A number chosen by the user to be used in conjunction with their telephone number when shopping online and using secure phone cash as their method of payment. The shopping code is NOT the same as the pin number. The sole purpose of the shopping code is to let the system know if it should bother calling the user or not.

When shopping online, all a user needs to provide to a merchant is their telephone number and shopping code. No divulging financial information; no worry that a hacker may break into that merchant's database and steal your bank account information or credit card numbers; no fear whatsoever of shopping online since the most anyone could get from that merchant's database is your phone number. There is nothing they could do with it as far as getting money. We use the shopping code to prevent the system from calling the user for transactions that they did not initiate. Let's say that it's 2:00 a.m. and another user shopping online mistypes their telephone number and supplies yours in the telephone number field. If it were not for that shopping code, chances are that the legitimate owner of the mistyped telephone number would be quite upset to get a phone call at that time of the night on a transaction they have nothing to do with. This is avoided thanks to the shopping code since in addition to mistyping or trying to play a prank, the person mistyping would also need to know the users shopping code before the system ever calls the user. Once the shopping code matches the telephone number, the system would call to verify the transaction and at that point the user would enter their pin number to confirm their identity. Therefore, even if someone found a user's shopping code, they still would not be able to get money out of the user's account.

Voice Print: During the registration process, the user MUST record some kind of sound. That sound will be played to the user anytime the system calls, before asking the user to enter their pin number. If that sound byte is not played at the beginning of the call. The user can be certain that the call is NOT from registration system and they SHOULD NOT enter their pin. The reason for this safeguard is that it is extremely easy to fake caller ids and unscrupulous people will try to con users into entering their pin numbers by spoofing the caller id of the registration system. However, since they won't have the user's voice print on file, the user will easily identify them as fakes. Furthermore, even if the con artist was able to get the pin number, that pin would be useless to them unless they are also in possession of the user's telephone or of an un-expired cashcode belonging to that user.

ANI: Automatic Number Identification. When a user calls the system, we do an ANI authentication which allows us to route the user to the appropriate menu. The ANI is a little more difficult to fake than a caller id but even if someone were to spoof it, it wouldn't do them any good, for the system always calls back before access is given to any account or any type of transaction is allowed. No amount of faking or ANY spoofing would do a con artist any good. Furthermore, additional security features including reverse provider look up and matching will virtually eliminate the risk of ANI spoofing.

### DESCRIPTION

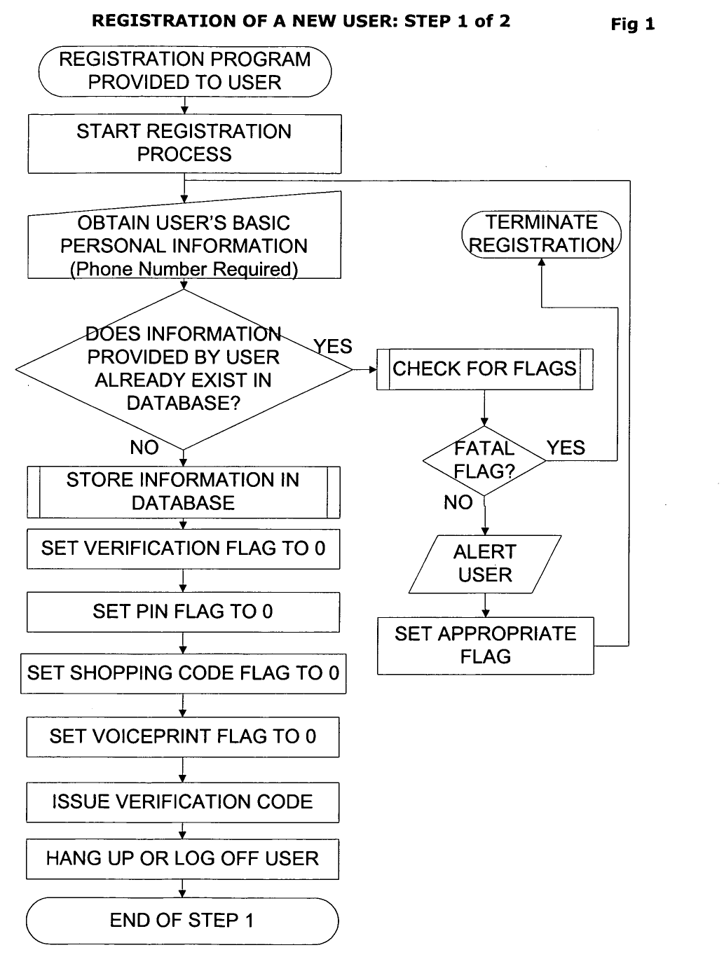

As seen in FIGS. 1-3 and 8, a business method for using phones to transact financial transactions comprises registering the user with a registration system. Having the user initiate a financial transaction over a specific telephone. Verifying if the initiated user financial transaction is legitimate and having user manually confirm transaction. Transferring funds in accordance with user instructions provided when the user initiated the financial transaction.

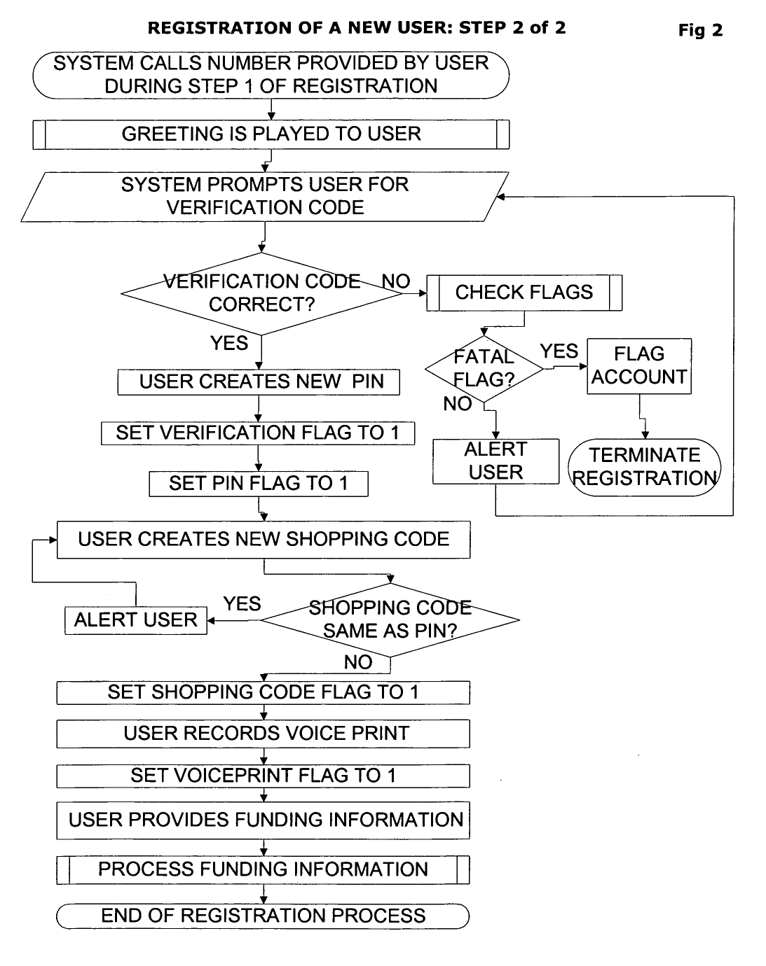

As seen in FIGS. 1-2, in the registering the user with a registration system step of the business method for using phones to transact financial transactions, the registration system step comprises the steps of providing a user with a registration system to open an account. Then, having the user submit his/her personal information, name, address, telephone number, identification of mobile or fixed phone, and any other contact information into the registration system's secured database. Next, having a secured server validate the information provided by the user against existing data in the registration database to prevent user from having a duplicate account, thereby minimizing the possibility of a third party accessing the user's account. Then, recording the user's validated information into the registration system's secured database. Issuing a verification code to the user immediately after the user's information is recorded. Then, initiating the registration system to call the telephone number provided by the user, wherein the system is going to request that the user enter the verification code previously provided. Next, having the registration system check the verification code provided by the user for a match, if a match, then user continues with the registration process, if no match after a predetermined number of attempts, then the user's registration will be terminated and flagged. After the match, instructing the user to create a pin number and a shopping code, wherein the pin number and the shopping code cannot be the same, and instructing the user to record a voice print. Then, having the user create the pin number, the shopping code and record the voice print. Next, instructing the user to enter a method of funding his account. Then, having the registration system verify that the account belongs to the user, if account belongs to user, then allowing system to process his requests, if the account does not belong to the user, then notifying user of discrepancy and possibly flagging the account if user does not correct discrepancy. Lastly, having the system mail user an address verification code, wherein the user is made to manually enter information into system to fully unlock his account, thereby allowing user to transact unabridged financial transaction over the telephone.

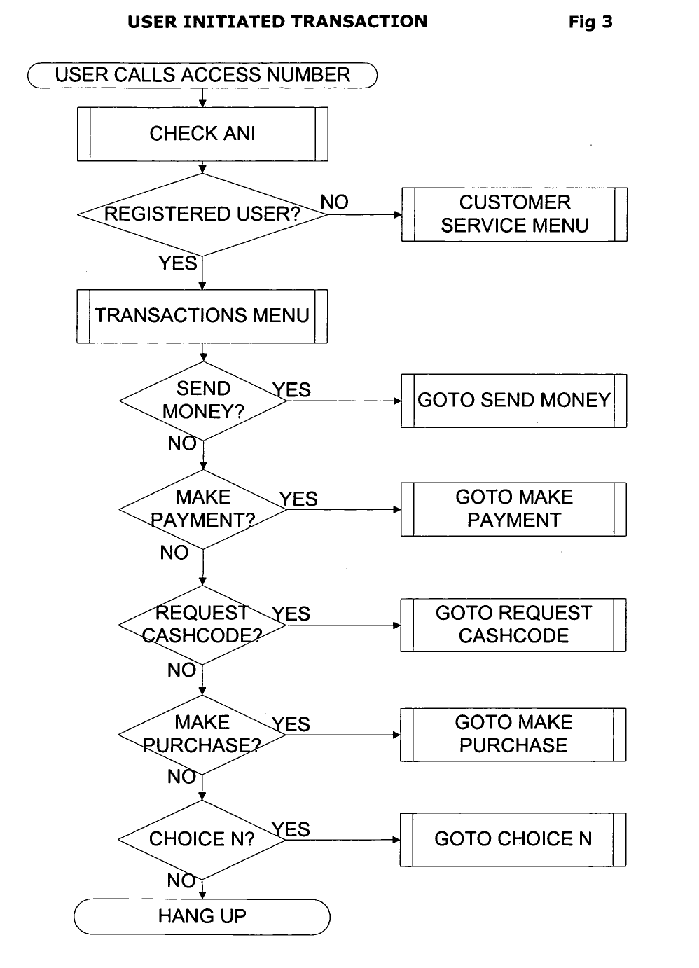

As seen in FIG. 3, in the having the user initiate a financial transaction over a specific telephone step of the business method for using phones to transact financial transactions, then having the user initiate a financial transaction step comprises the steps of having user call the registration system from the telephone number provided in his/her personal information to initiate any transaction. Then, checking the automatic number identification to see if the number is registered in the registration system's database, if so prompting the user to enter the type of transaction desired. Lastly, having user enter the transaction desired and then instructing user to terminate call.

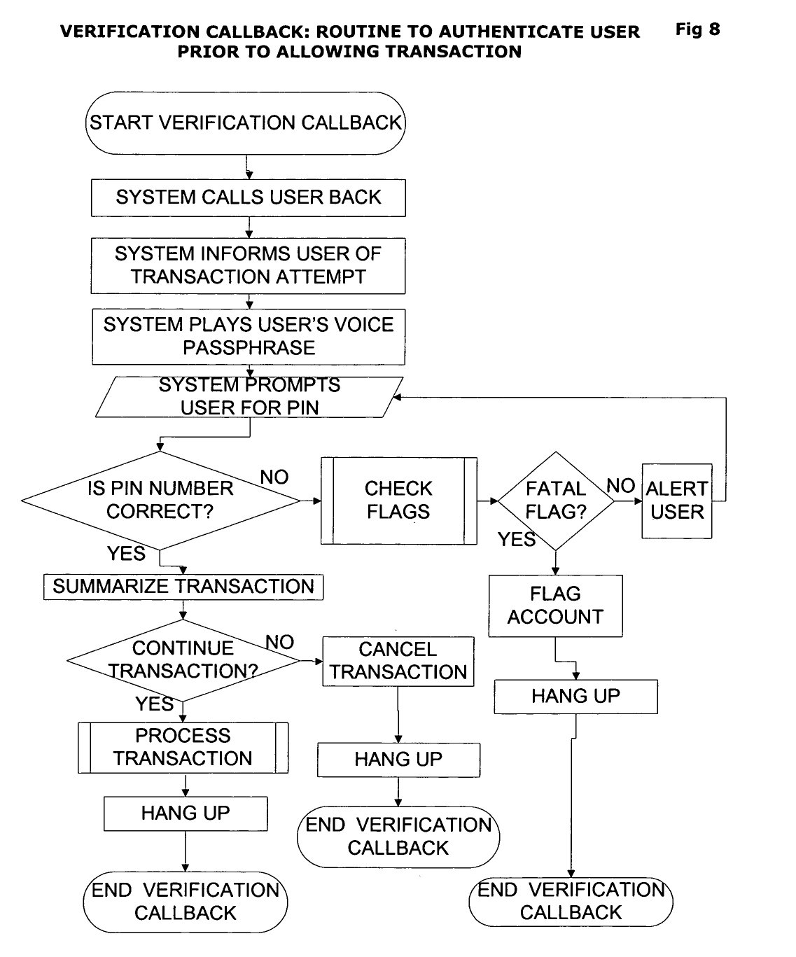

As seen in FIG. 8, in the verifying if the initiated user financial transaction is legitimate step, the verifying step comprises the steps of calling the user and playing the voice print and instructing user to enter the pin number. Then, if the user recognizes his voice, having the user enter his pin. Lastly, checking the pin for authenticity, if authentic, then continuing with the transaction, if not then repeating the above two steps a predetermined amount of times prior to flagging the user and terminating the transaction.

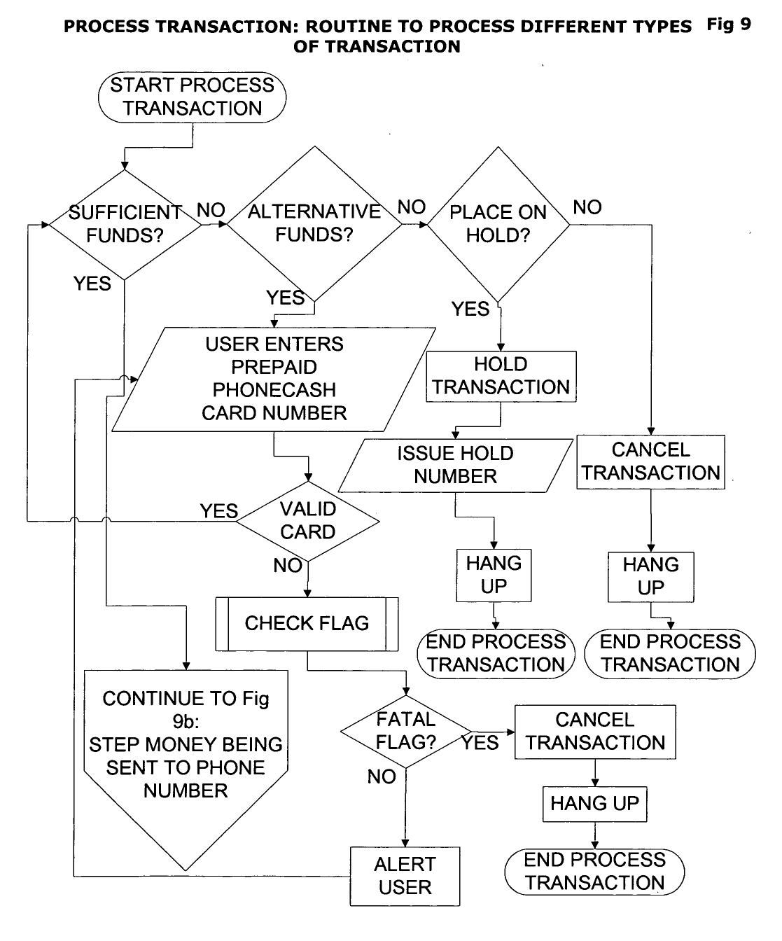

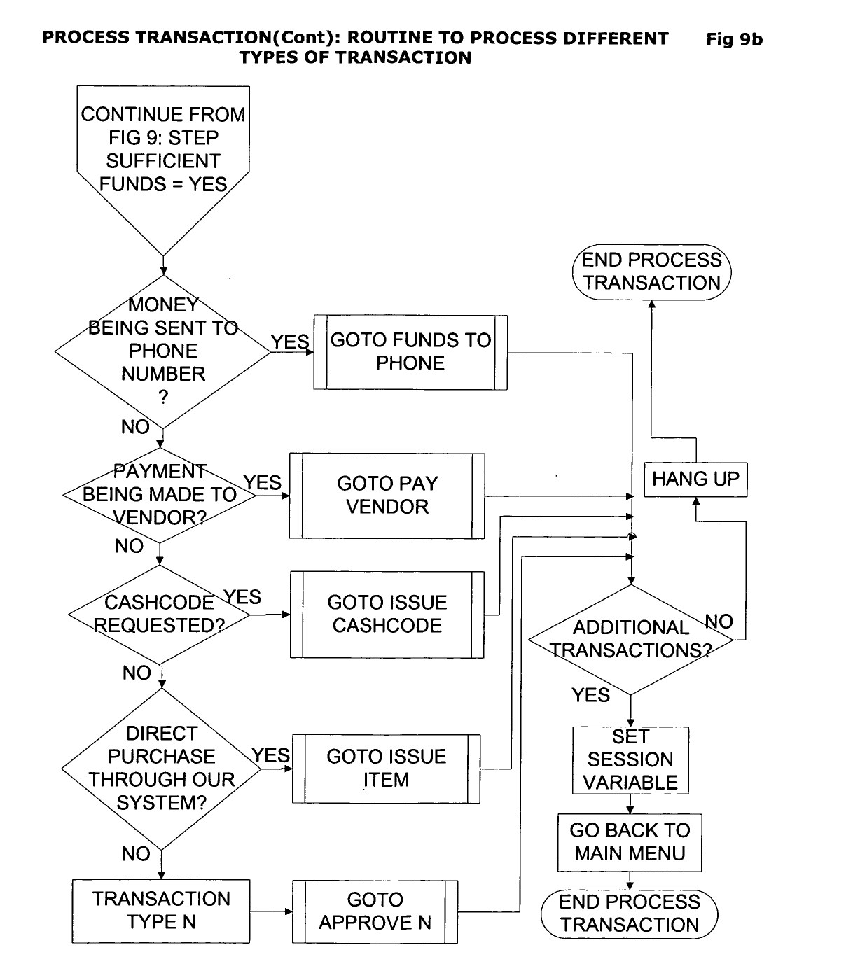

As seen in FIG. 9, in the transferring funds in accordance with user instruction step, the step comprises instructing the registration system to check for the availability of funds, if funds available, then transaction shall continue, if funds not available, then the transaction shall be either placed on hold or terminated, if transaction does not originate from the user, then the account will be flagged for monitoring and the transaction shall be terminated. If the funds are available, then withdrawing the funds from the source previously provided by the user, passing the funds through the registration system, and delivering the funds to a third party or location. The funds may be transferred to a third party or location by providing a validation code to the user that corresponds with the transaction. The user may be able to display the bar code in his cellular phone or he may download the code from a computer.

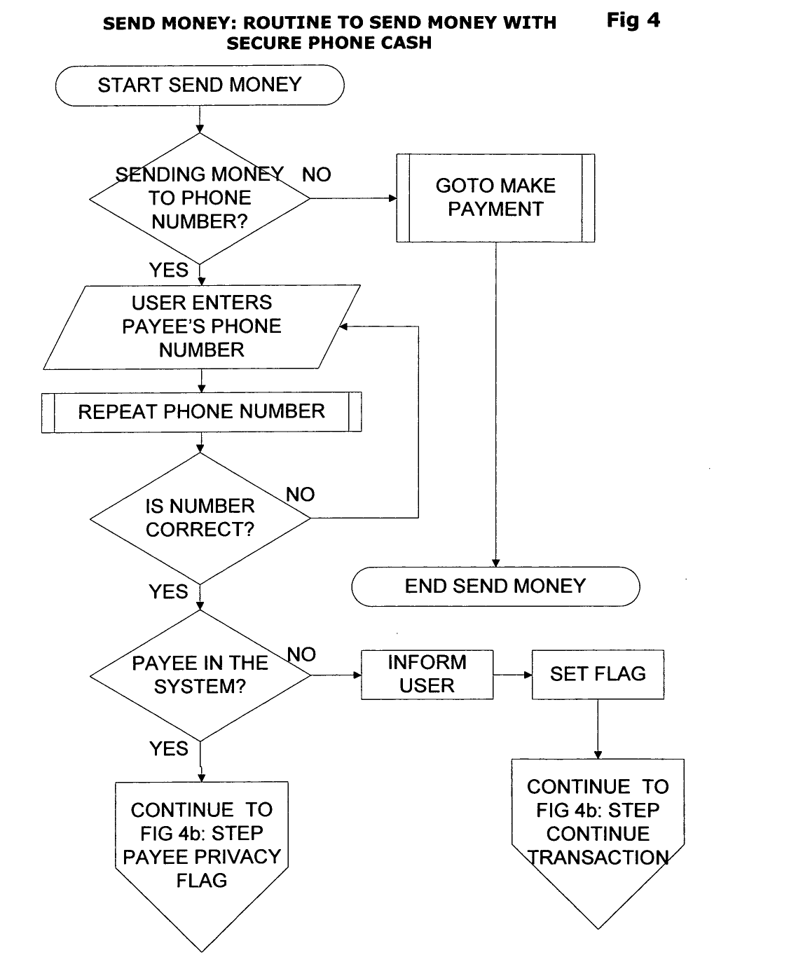

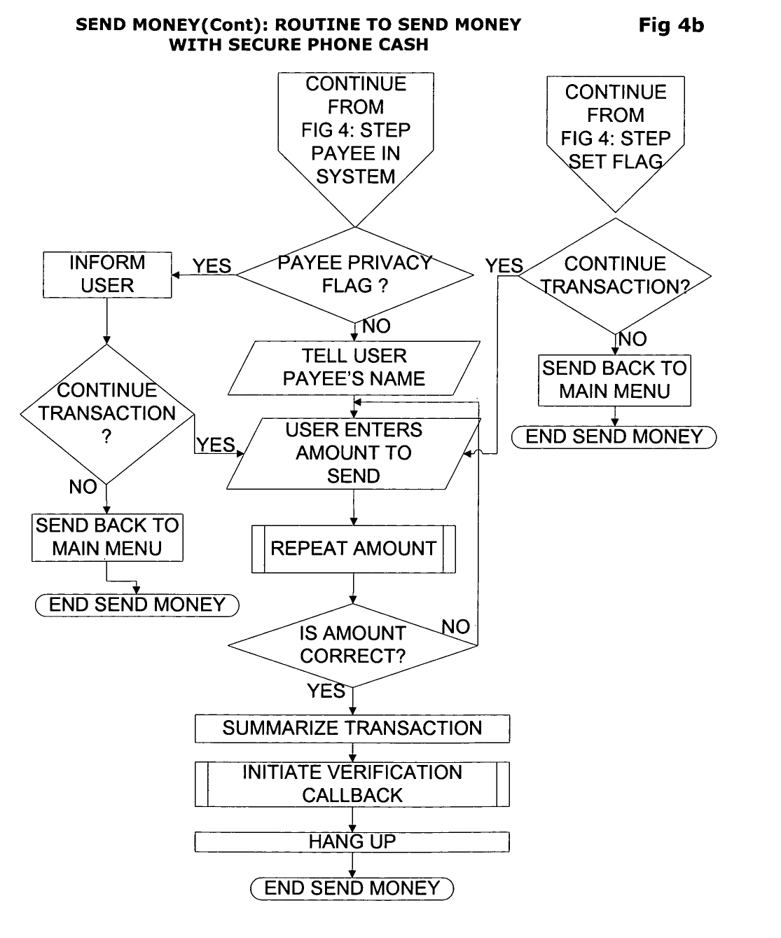

As seen in FIG. 4, the transaction the user transacts could be sending money with secure phone cash.

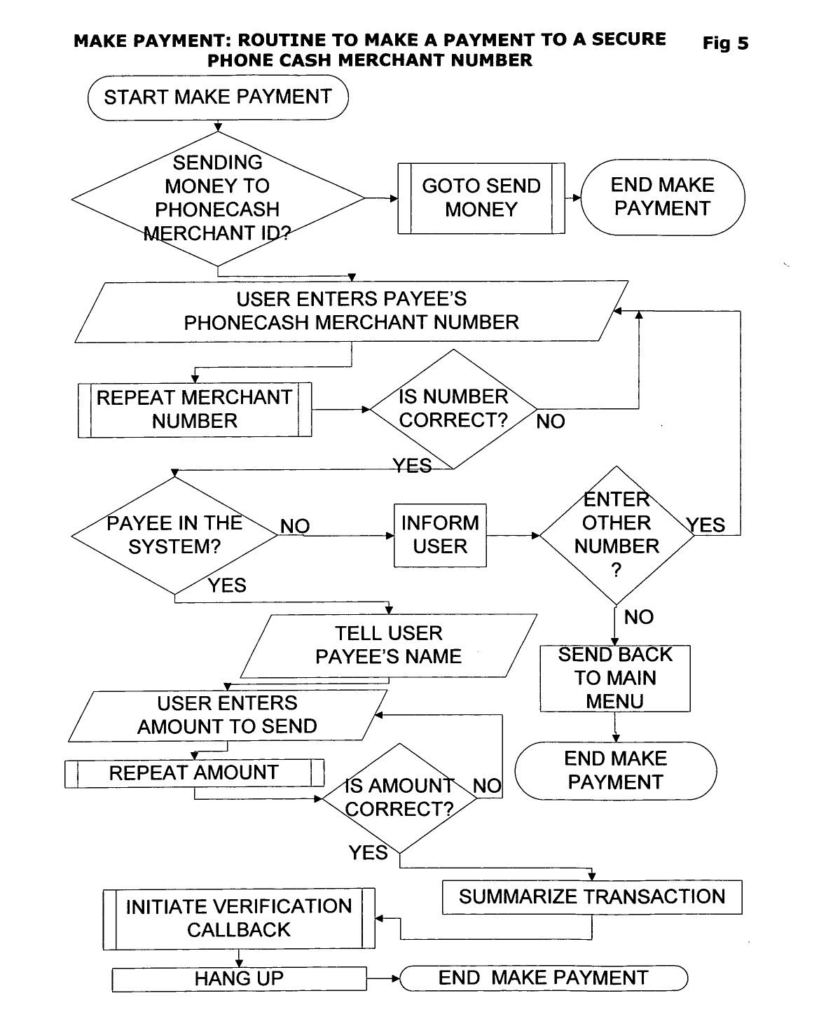

As seen in FIG. 5, the transaction the user transacts could be making a payment to a secure phone cash merchant.

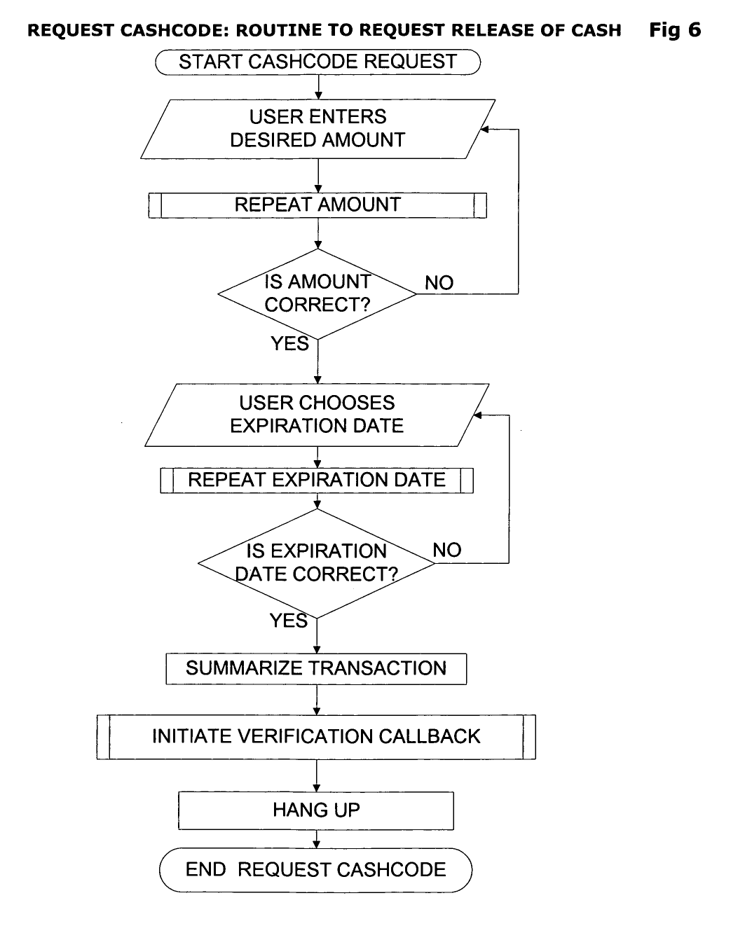

As seen in FIG. 6, the transaction the user transacts could be a routine request to have cash released to user.

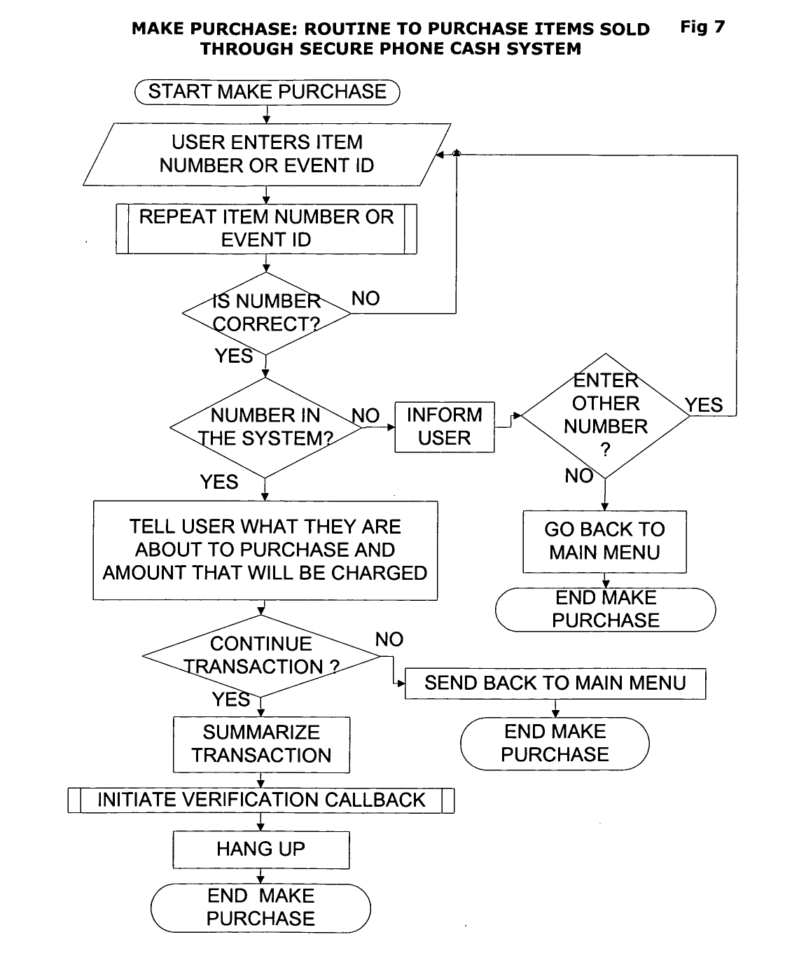

As seen in FIG. 7, the transaction the user transacts could be to purchase items through a secure phone cash system.

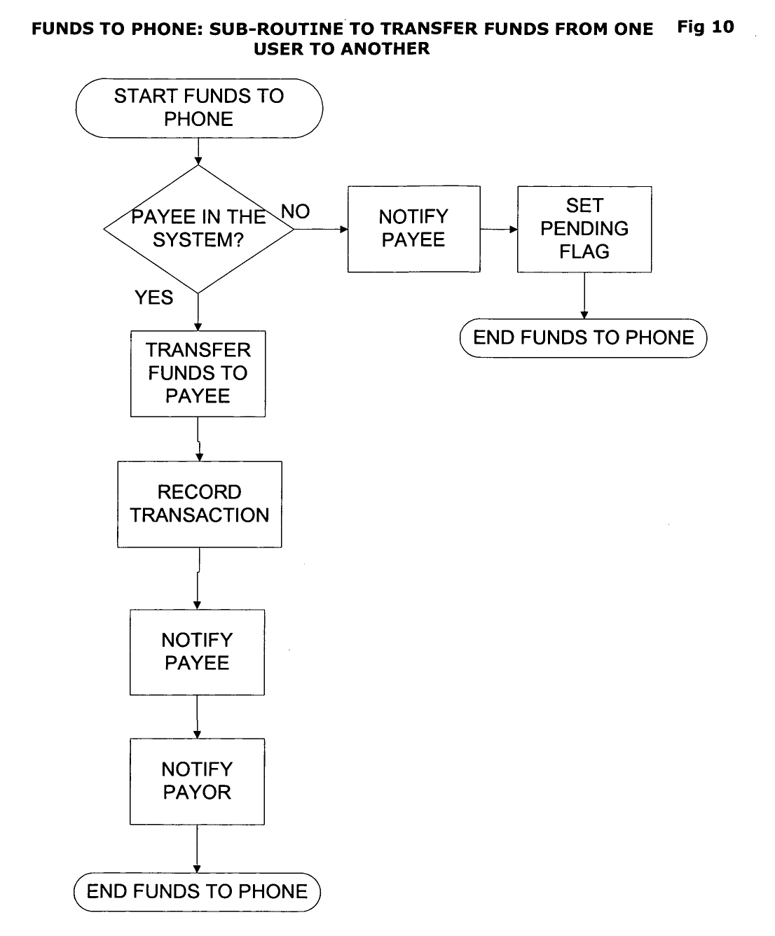

A seen in FIG. 10, the transaction the user transacts could be to transfer funds from one user to another.

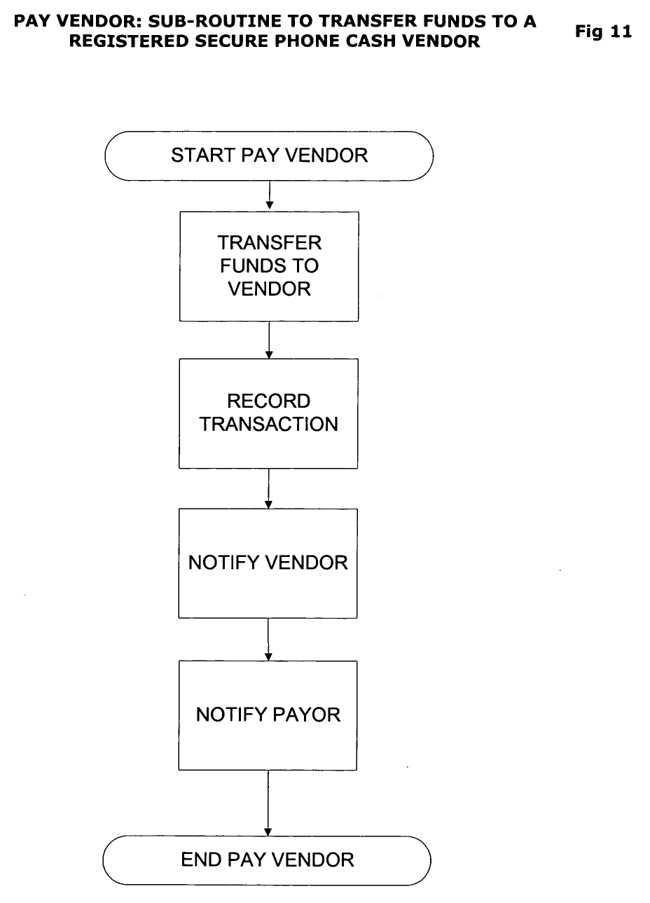

As seen in FIG. 11, the transaction the user transacts could be to transfer funds to a registered secured phone cash vendor.

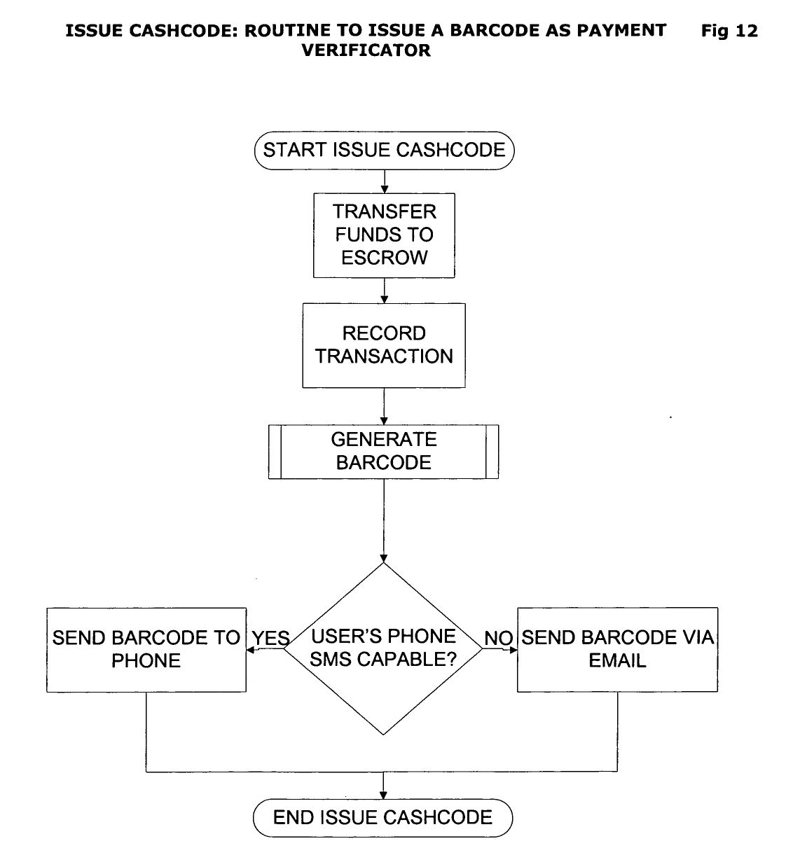

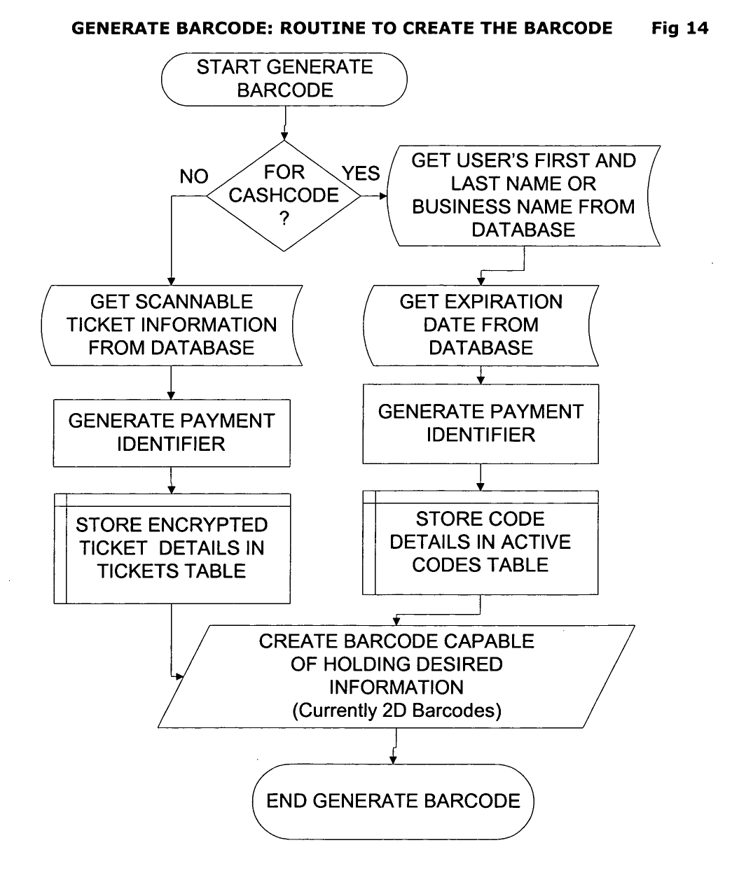

As seen in FIGS. 12 and 14, the transaction the user transacts could be to issue a bar code as a payment verificator.

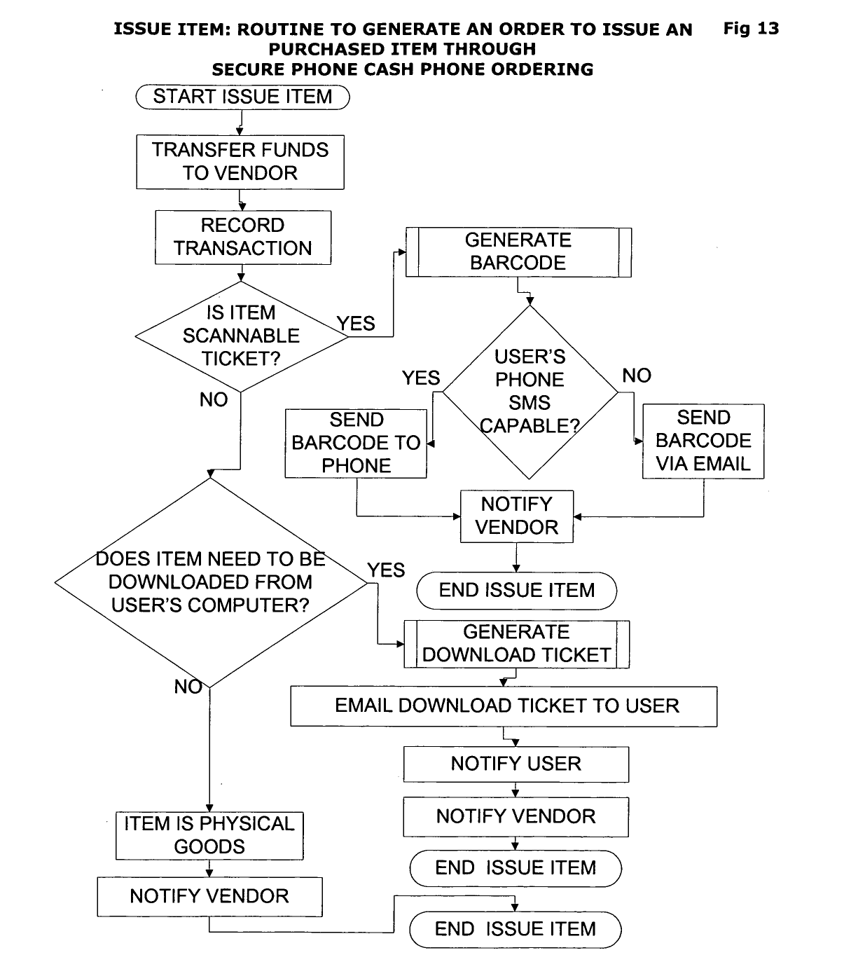

As seen in FIG. 13, the transaction the user transacts could be to generate an order to issue a purchased item through a secure phone cash ordering system.

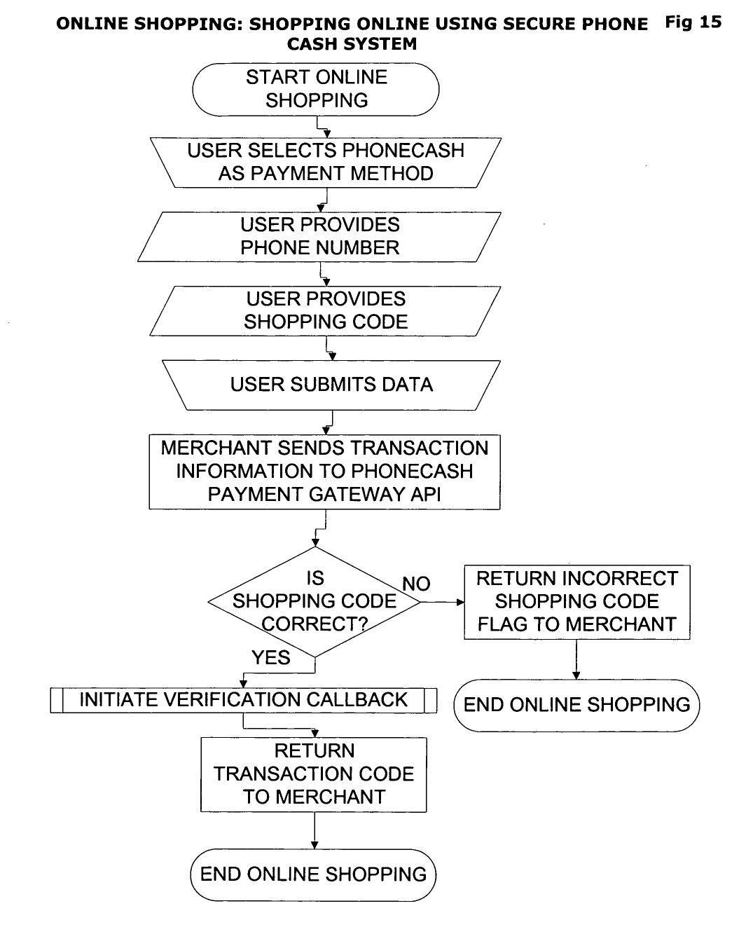

As seen in FIG. 15, the transaction the user transacts could be online using a secure phone cash system.

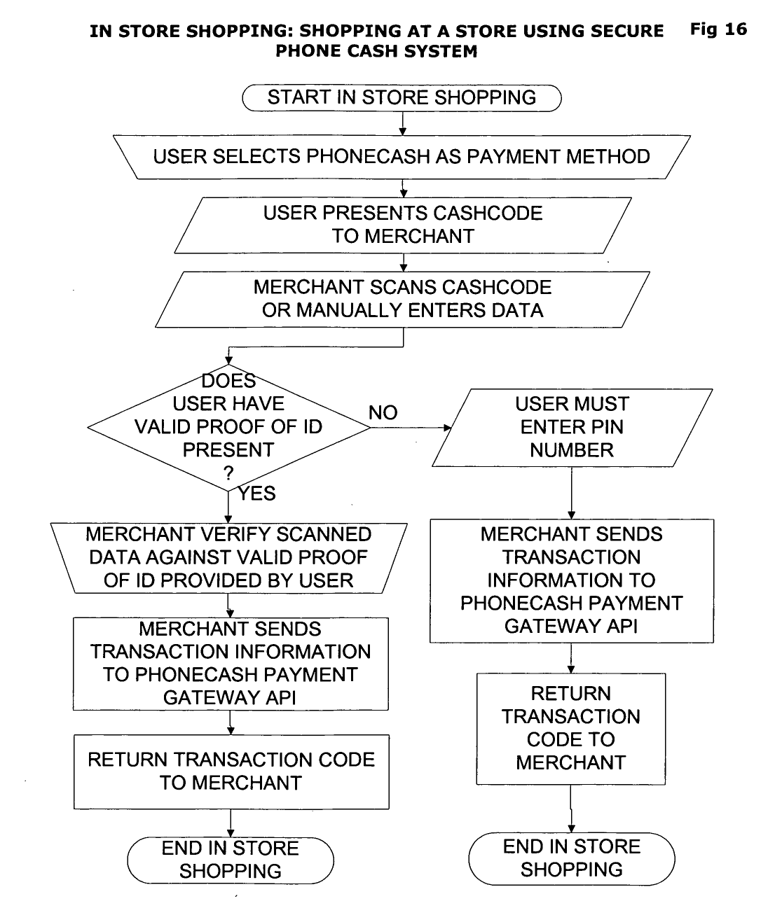

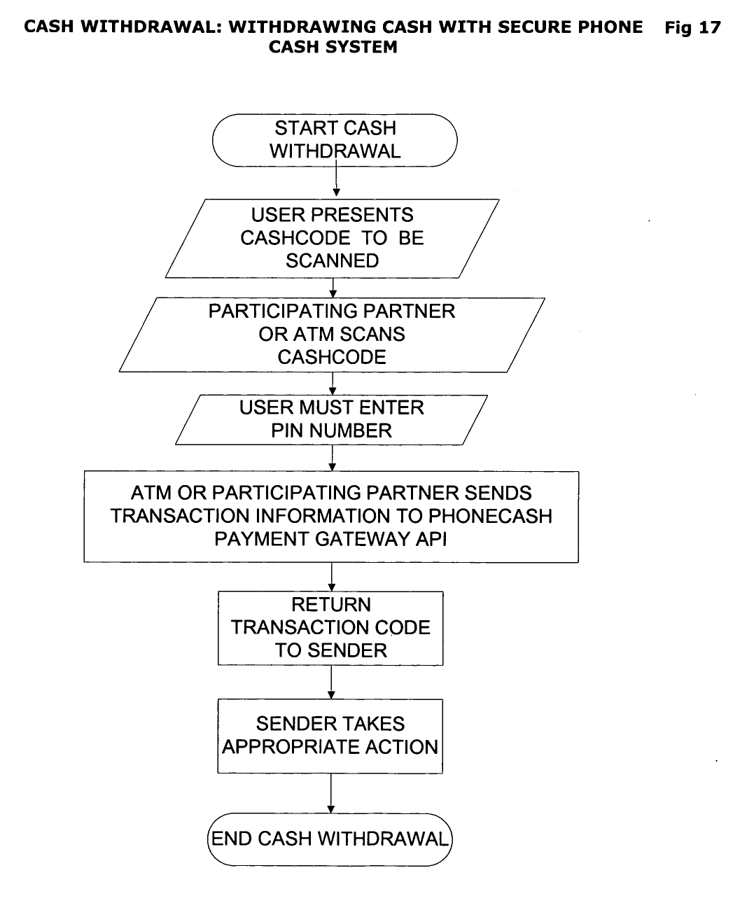

As seen in FIG. 16, the transaction the user transacts could be shopping at a store using a secure phone cash system.

An object of the present invention is to provide a user with a financial device that will insure that any funds he wishes to transfer to any third party is verified prior to the funds being released to a third party.

Another object of the present invention is to prevent white collar criminals from using a user's financial account.

A further object of the present invention is to provide a user with an alternative means to purchase items besides cash, checks or credit.

Yet a further object of the present invention is to insure that a user using the financial device does not overdraw his financial accounts.

Still a further object of the present invention is to provide the user with a financial device that can print or display a barcode that can be redeemed for cash or used as a form of payment at third party outlets.

Although the present invention has been described in considerable detail with reference to certain preferred versions thereof, other versions are possible. Therefore the spirit and the scope of the claims should not be limited to the description of the preferred versions contained herein.

What is claimed is:

1. A business method for using phones to transact financial transactions, comprises the steps of:
registering the user with a registration system;
having the user initiate a financial transaction over a specific telephone;
verifying if the initiated user's financial transaction is legitimate and having the user manually confirm transaction; and
transferring funds in accordance with user instructions provided when the user initiated the financial transaction.

2. The business method of claim 1, wherein the registering the user with a registration system step, comprises the steps of:
providing a user with a registration system to open an account;
having the user submit his/her personal information, name, address, telephone number, identification of mobile or fixed phone, and any other contact information into the registration system's secured database;
having a secured server validate the information provided by the user against existing data in the registration database to prevent user from having a duplicate account, thereby minimizing the possibility of a third party accessing the user's account;
recording the user's validated information into the registration system's secured database;
issuing a verification code to the user immediately after the user's information is recorded;
initiating the registration system to call the telephone number provided by the user, wherein the system is going to request that the user enter the verification code previously provided;
having the registration system check the verification code provided by the user for a match, if a match, then user continues with registration process, if no match after a predetermined number of attempts, then user's registration will be terminated and flagged;
if a match, instructing the user to create a pin number and a shopping code, wherein the pin number and the shopping code cannot be the same, and instructing the user to record a voice print;
having the user create the pin number, the shopping code and record the voice print;
instructing the user to enter a method of funding his account;
having the registration system verify that the account belongs to the user, if account belongs to user, then allowing system to process his requests, if the account does not belong to the user, then notifying user of discrepancy and possibly flagging the account if user does not correct discrepancy; and
having the system mail user an address verification code, wherein the user is made to manually enter information into system to fully unlock his account, thereby allowing the user to transact unabridged financial transactions over the telephone.

3. The business method of claim 2, wherein the having the user initiate a financial transaction over a specific telephone step, comprises the steps of:
having user call the registration system from the telephone number provided in his/her personal information to initiate any transaction;
checking the automatic number identification to see if the number is registered in the registration system's database, if so prompting the user to enter the type of transaction desired; and
having user enter the transaction desired and then instructing user to terminate call.

4. The business method of claim 3, wherein the verifying if the initiated user financial transaction is legitimate step, comprises the steps of:
calling the user and playing the voice print and instructing user to enter the pin number;
having the user enter his pin, if the user recognizes his voice; and
checking the pin for authenticity, if authentic, then continuing with transaction, if not then repeating the above two steps a predetermined amount of times prior to flagging the user and terminating the transaction.

5. The business method of claim 4, wherein the transferring funds in accordance with user instruction step, comprises the steps of:
instructing the registration system to check for the availability of funds, if funds available, then transaction shall continue, if funds not available, then transaction shall be either placed on hold or terminated, if transaction does not originate from the user, then the account will be flagged for monitoring and the transaction shall be terminated; and
if the funds are available, withdrawing the funds from the source previously provided by the user, passing the funds through the registration system, and delivering the funds to a third party or location.

6. The business method of claim 5, wherein the transaction the user transacts could be sending money with secure phone cash.

7. The business method of claim 6, wherein the transaction the user transacts could be making a payment to a secure phone cash merchant.

8. The business method of claim 7, wherein the transaction the user transacts could be a routine request to have cash released to user.

9. The business method of claim 8, wherein the transaction the user transacts could be to purchase items through a secure phone cash system.

10. The business method of claim 9, wherein the transaction the user transacts could be to transfer funds from one user to another.

11. The business method of claim 10, wherein the transaction the user transacts could be to transfer funds to a registered secured phone cash vendor.

12. The business method of claim 11, wherein the transaction the user transacts could be to issue a bar code as a payment verificator.

13. The business method of claim 12, wherein the transaction the user transacts could be to generate an order to issue a purchased item through a secure phone cash ordering system.

14. The business method of claim 13, wherein the transaction the user transacts could be online using a secure phone cash system.

15. The business method of claim 14, wherein the transaction the user transacts could be shopping at a store using a secure phone cash system.

16. A business method of providing a phone user a means for securely transferring or receiving funds to or from a third party using any type of telephone, comprising the steps of:
providing a user with a registration system to open an account;
having the user submit his/her personal information, name, address, telephone number, identification of mobile or fixed phone, and any other contact information into the registration system's secured database;
having a secured server validate the information provided by the user against existing data in the registration database to prevent user from having a duplicate account, thereby minimizing the possibility of a third party accessing the user's account;
recording the user's validated information into the registration system's secured database;
issuing a verification code to the user immediately after the user's information is recorded;
initiating the registration system to call the telephone number provided by the user, wherein the system is going to request that the user enter the verification code previously provided;
having the registration system check the verification code provided by the user for a match, if a match, then user continues with registration process, if no match after a predetermined number of attempts, then user's registration will be terminated and flagged;
after the match, instructing the user to create a pin number and a shopping code, wherein the pin number and the shopping code cannot be the same, and instructing the user to record a voice print;
having the user create the pin number, the shopping code and record the voice print;
instructing the user to enter the method of funding his account;
having the registration system verify that the account belongs to the user, if account belongs to user, then allowing system to process his requests, if the account does not belong to the user, then notifying user of discrepancy and possibly flagging the account if user does not correct discrepancy;
having the system mail user an address verification code, wherein the user is made to manually enter information into system to fully unlock his account, thereby allowing user to transact unabridged financial transaction over the telephone;
having user call the system from the telephone number provided in his/her personal information to initiate any transaction;
checking the automatic number identification to see if the number is registered in the registration system's database, if so prompting the user to enter the type of transaction desired;
having user enter the transaction desired and then instructing user to terminate call;
instructing system to call back the user's telephone number and play the voice print to verify the transaction originated from the user's registered telephone and instructing the user to enter the pin number;
if the user enters the correct pin number, then instructing the system to check for availability of funds, if funds available, then transaction shall continue, if funds not available, then transaction shall be either placed on hold or terminated, if transaction does not originate from the user, then the account will be flagged for monitoring and the transaction shall be terminated; and
if the funds are available, then withdrawing the funds from the source previously provided by the user, passing the funds through the registration system, and delivering the funds to a third party or location.

17. The business method of claim 16, wherein the transaction the user transacts could be sending money with secure phone cash.

18. The business method of claim 17, wherein the transaction the user transacts could be making a payment to a secure phone cash merchant.

19. The business method of claim 18, wherein the transaction the user transacts could be a routine request to have cash released to user.

20. The business method of claim 19, wherein the transaction the user transacts could be to purchase items through a secure phone cash system.

21. The business method of claim 20, wherein the transaction the user transacts could be to transfer funds from one user to another.

22. The business method of claim 21, wherein the transaction the user transacts could be to transfer funds to a registered secured phone cash vendor.

23. The business method of claim 22, wherein the transaction the user transacts could be to issue a bar code as a payment verificator.

24. The business method of claim 23, wherein the transaction the user transacts could be to generate an order to issue a purchased item through a secure phone cash ordering system.

25. The business method of claim 24, wherein the transaction the user transacts could be online using a secure phone cash system.

26. The business method of claim 25, wherein the transaction the user transacts could be shopping at a store using a secure phone cash system.
